(19) United States
(12) Patent Application Publication
(10) Pub. No.: US 2018/0137579 A1
(43) Pub. Date: May 17, 2018

(54) METHOD FOR OPTIMIZING CROP PRODUCTION EFFICIENCY AND APPARATUS FOR THE SAME

(71) Applicant: ELECTRONICS AND TELECOMMUNICATIONS RESEARCH INSTITUTE, Daejeon (KR)

(72) Inventors: Hyeon PARK, Daejeon (KR); Jee Sook EUN, Daejeon (KR); Myung Eun KIM, Daejeon (KR); Se Han KIM, Daejeon (KR); In Gook JANG, Daejeon (KR)

(21) Appl. No.: 15/705,711

(22) Filed: Sep. 15, 2017

(30) Foreign Application Priority Data
Nov. 15, 2016 (KR) 10-2016-0151927
Jul. 31, 2017 (KR) 10-2017-0097340

(51) Int. Cl. G06Q 50/02; G06Q 10/06; G06N 99/00; G05B 23/02

(52) U.S. Cl. CPC G06Q 50/02; G06Q 10/0637; G05B 23/0227; G06Q 10/06395; G06N 99/005; G06Q 10/067

(57) ABSTRACT

An apparatus and method for optimizing crop production efficiency. The method includes collecting growth information of each farm, acquiring at least one supply resource variable by comparing the collected growth information with a preset reference model, training influence of the at least one supply resource variable on production efficiency, and building an analysis model which shows production efficiency according to the at least one supply resource variable as a result of the training. Accordingly, production efficiency can be optimized by reflecting local characteristics of each farm on the reference model.

### CROSS-REFERENCE TO RELATED APPLICATIONS

This application claims priority to Korean Patent Application No. 10-2016-0151927, filed Nov. 15, 2016, and Korean Patent Application No. 10-2017-0097340, filed Jul. 31, 2017, in the Korean Intellectual Property Office (KIPO), the entire contents of which are hereby incorporated by reference.

### BACKGROUND

### 1. Field of the Invention

Example embodiments of the present invention relate to a method of optimizing crop production efficiency and an apparatus for the same, and more specifically to a method of optimizing crop production efficiency in which a reference model is dynamically applied to the optimize crop production efficiency by providing supply resources according to the reference model to each farm, estimating crop production efficiency based on collected growth information, and renewing the reference model according to a production result, and an apparatus for the same.

### 2. Description of Related Art

Currently, farms which produce greenhouse crops can control growth states of the crops to increase crop production efficiency by controlling an environment of a greenhouse, such as temperature, humidity, and an amount of solar radiation.

Here, one general method of controlling an environment is for an operator or farm to directly control a complex controller or system to control the environment. However, since the operator or farm controls the environment on the basis of an intuitive determination, there are problems in that an effect of increasing an amount of production or cost reduction is not significant and control errors frequently occur.

In addition, although various studies related to facility greenhouses define models related to environmental information and growth information, since the environmental information and a growth state related to growth is changed according to a local environment in which crops are cultivated, it is difficult to expect an increase in crop production efficiency through a standardized model.

Accordingly, a method of optimizing supply resources and increasing crop production efficiency by not supplying a standardized reference model but supplying an optimum production efficiency model corresponding to a local environment is required.

### SUMMARY

Accordingly, example embodiments of the present invention are provided to substantially obviate one or more problems due to limitations and disadvantages of the related art.

Example embodiments of the present invention provide a method of optimizing crop production efficiency.

Example embodiments of the present invention also provide an apparatus for optimizing crop production efficiency.

According to one aspect of the present invention, there is provided a method of optimizing crop production efficiency.

Here, in some example embodiments, a method of optimizing crop production efficiency performed by an apparatus for optimizing crop production efficiency, and the method includes collecting growth information of each farm, acquiring at least one supply resource variable by comparing the collected growth information with a preset reference model, training influence of the at least one supply resource variable on production efficiency; and building an analysis model which shows production efficiency according to the at least one supply resource variable as a result of the training.

Here, the collecting of the growth information may include collecting the growth information in each ordered period according to the preset reference model.

Here, the growth information may include at least one among disease information, diagnostic information of a growth controller, growth environment information, and growth activity information.

Here, the disease information may denote a result of estimating one of a disease occurrence probability and whether a disease occurs by performing deep learning on a disease image input by an operator of each of the farms.

Here, the diagnostic information of the growth controller may include a result of diagnosing whether a malfunction of the growth controller occurs by comparing a control value of the growth controller with a growth environment value corresponding to the growth controller.

Here, the method may further include estimating production efficiency according to the growth information of each of the farms by using the analysis model, and transmitting a recommendation or warning message to each of the farms on the basis of a result of the estimation.

Here, the transmitting of the message may include transmitting a message which recommends that a required supply resource value be supplied to each of the farms according to the reference model when the estimated production efficiency is less than production efficiency according to the reference model.

Here, the method may further include preprocessing the growth information after the collecting of the growth information.

Here, the preprocessing may include verifying a meaning of the growth information or checking an average value or central point of the growth information to remove information determined as an abnormal value from the growth information or to convert a data form of the growth information into a data form with which the growth information is processable.

Here, the method further includes, when harvesting at each of the farms is confirmed to be finished, selecting a farm or ordered period having the best production efficiency by evaluating production efficiency of each of the farms, comparing the production efficiency according to the selected farm or ordered period with production efficiency according to the preset reference model, and renewing the preset reference model by reflecting the growth information according to the selected farm or ordered period thereon when the production efficiency according to the selected farm or ordered period is greater than the production efficiency according to the preset reference model.

According to another aspect of the present invention, there is provided an apparatus for optimizing crop production efficiency.

Here, in other example embodiments, the apparatus for optimizing crop production efficiency includes at least one processor, and a memory which stores commands configured to command the at least one processor to perform at least one operation,

Here, the at least one operation includes collecting growth information of each farm, acquiring at least one supply resource variable by comparing the collected growth information with a preset reference model, training influence of the at least one supply resource variable on production efficiency, and building an analysis model which shows production efficiency according to the at least one supply resource variable as a result of the training.

Here, the collecting of the growth information may include collecting the growth information in each ordered period according to the preset reference model.

Here, the growth information may include at least one among disease information, diagnostic information of a growth controller, growth environment information, and growth activity information.

Here, the disease information may include a result of estimating one of a disease occurrence probability and whether a disease occurs by performing deep learning on a disease image input by an operator of each of the farms.

Here, the diagnostic information of the growth controller may include a result of diagnosing whether a malfunction of the growth controller occurs by comparing a control value of the growth controller with a growth environment value corresponding to the growth controller.

Here, the commands may command the at least one processor to further perform estimating production efficiency according to the growth information of each of the farms by using the analysis model, and transmitting a recommendation or warning message to each of the farms on the basis of a result of the estimation.

Here, the transmitting of the message may include transmitting a message which recommends that a required supply resource value be supplied to each of the farms according to the reference model when the estimated production efficiency is less than production efficiency according to the reference model.

Here, the command may command the at least one processor to further perform preprocessing the growth information after the collecting of the growth information.

Here, the preprocessing may include verifying a meaning of the growth information or checking an average value or central point of the growth information to remove information determined to be an abnormal value from the growth information or to convert the growth information into a data form to be processable.

Here, when harvesting at each of the farms is confirmed to be finished, the commands may command the at least one processor to further perform selecting a farm or ordered period having the best production efficiency by evaluating production efficiency of each of the farms, comparing the production efficiency according to the selected farm or ordered period with production efficiency according to the preset reference model; and renewing the preset reference model by reflecting the growth information according to the selected farm or ordered period thereon when the production efficiency according to the selected farm or ordered period is greater than the production efficiency according to the preset reference model.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view illustrating an overall system for performing a method of optimizing crop production efficiency according to one embodiment of the present invention;

FIG. 2 is a conceptual diagram illustrating the overall system for performing the method of optimizing crop production efficiency according to one embodiment of the present invention from a functional viewpoint;

FIG. 3 is a conceptual diagram illustrating an algorithm for optimizing crop production efficiency according to one embodiment of the present invention;

FIG. 4 is a conceptual diagram for describing supply resources according to a reference model in the case in which a control point in an ordered period according to one embodiment of the present invention is temperature;

FIG. 5 is a conceptual diagram related to data accumulation for optimizing crop production efficiency according to one embodiment of the present invention;

FIG. 6 is a conceptual table related to result data of each farm for optimizing crop production efficiency according to one embodiment of the present invention;

FIG. 7 is a conceptual diagram related to a reference model renewal for optimizing crop production efficiency according to one embodiment of the present invention;

FIG. 8 is a flowchart illustrating the method of optimizing crop production efficiency according to one embodiment of the present invention; and

FIG. 9 is a conceptual diagram related to apparatus for optimizing crop production efficiency according to one embodiment of the present invention apparatus.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in thert to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A method of optimizing crop production efficiency according to one embodiment of the present invention and an apparatus for the same may optimize a model by renewing a reference model according to a control result according to production efficiency estimation and a result evaluation according to current state comparative analysis. Such a method of optimizing crop production efficiency according to one embodiment of the present invention and an apparatus for the same may perform the following important functions.

That is, the reference model may be renewed according to information accumulated for production efficiency analysis, training in consideration of a variable of production efficiency influence, estimated production efficiency based on a training model, and a production efficiency result of each farm.

More specifically, environmental information of a greenhouse may be collected by sensors installed in the greenhouse and transmitted through a cloud to analyze production efficiency, growth information (the number of leaves, a length of a leaf, a diameter of a stem, and the like) of a crop (for example, a strawberry) may be transmitted to an apparatus for optimizing crop production efficiency by a mobile terminal via a farming daily log of a farm, and a result of disease photo analysis may be transmitted to the apparatus for optimizing the crop production efficiency as disease information. The information collected through the above-described method may be stored in a big data cluster configured to store large amounts and various pieces of information in a distributed manner.

Production efficiency is analyzed on the basis of supply resource information and disease analysis result, which are collected, malfunction information of an environmental sensor/apparatus, and the like. The result of the analysis may be provided as information for controlling a greenhouse environment or as information for visualizing the analysis result, on the cloud on the cloud or for notifying a farm of a warning/recommendation.

More specifically, the production efficiency is analyzed through two′operations. The first operation is for monitoring crop growth, and a growth environment according to a generally known growth cycle (a planting period, an incubation period, a budding period, a flowering period, a fruit growth period, and a harvesting period) among supply resources may be set as an initial reference model. A current growth state and the growth environment (temperature, humidity, and solar radiation) may be monitored on the basis of the set reference model, and a value of the growth state and a value of the growth environment of the reference model may be compared such that the growth state and environment are controlled so that the reference model is followed.

The second operation is for building a production efficiency model, and a production efficiency analysis model may be generated on the basis of all of accumulated supply resource information, and current production efficiency corresponding to a control point in an ordered period may be extracted therefrom. To this end, the supply resources, a disease prediction analysis engine which processes a disease image, a malfunction diagnosis analysis engine which diagnoses a malfunction of an apparatus using ontology, and analysis result information extracted by a reference model state machine may be stored in Hadoop, which is a big data cluster, and the stored information may be used as input information for analyzing the production efficiency model.

The input information may be converted into analysis data through preprocessing process, and an analysis model may be built through training. An estimation analysis corresponding to a control point in each ordered period may be performed on the basis of the built analysis model, and a result of the performance of the estimation analysis and a result corresponding to the control point in the ordered period may be provided to a farm cloud server for a farm or operator and visualized.

More specifically, in the production efficiency analysis, influence levels of supply resources which may influence crop production efficiency may be calculated on the basis of the supply resource information accumulated for building the production efficiency model. Which supply resource influences the production efficiency estimation may be seen according to the influence level thereof. The built models may be built with, corresponding models according to supply resource information of farms. A practical production efficiency of each of the farms may be estimated by using a result of a reference model state machine and information of the remaining supply resources at a control point in each ordered period by using the built models.

A result of the production efficiency estimation may be extracted by using an influence level of a supply resource of a previously built analysis model, and such situational information may be visualized by a farm and an operator. The reference model may be renewed according to a renewal reference of the reference model (when an amount of production of the best farm is greater than that of the reference model production and the like) whenever harvest is finished. In addition, the reference model may be renewed by comparing an ordered period of the best farm to that of the reference model and reflecting a better ordered period on the reference model. The reference model renewed as described above may become a reference model as an adapted optimum model in which the renewed reference model is reflected since local environmental characteristics and supply resources do not match the reference model.

Specifically, production efficiency of each of the farms and production efficiency in each ordered period may be compared, and the best production efficiency model may be selected to evaluate the current reference model. In the case in which a production efficiency value according to the reference model is less than that of the current farm/ordered period, which is superior, the reference model may be renewed on the basis of information related to a growth environment of the superior farm/ordered period.

Hereinafter, the above-described exemplary embodiment of the present invention will be described in detail with reference to the accompanying drawings.

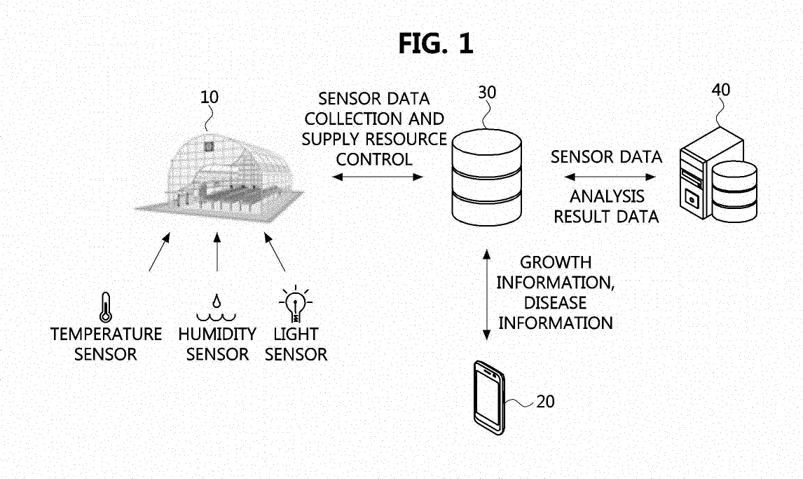

FIG. 1 is a conceptual view illustrating an overall system for performing a method of optimizing crop production efficiency according to one embodiment of the present invention.

Referring to FIG. 1, the overall system for performing the method of optimizing crop production efficiency according to one embodiment of the present invention may include a facility greenhouse 10 including various sensors, a mobile apparatus 20 configured to receive a farming daily log and the like from an operator or user of a farm, a farm cloud server 30 configured to receive various pieces of data from the facility greenhouse and the mobile apparatus, and/or an apparatus 40 for optimizing crop production efficiency configured to receive sensing data from the farm cloud server 30, optimize crop production efficiency, and provide an analysis result to the farm cloud server 30.

Here, since the various sensors are installed in the facility greenhouse 10, an Internet of Things (IoT) hub may be formed in the facility greenhouse 10, and the various sensors may collect information on an environment, which affects crop growth, such as temperature, humidity, and light, in the facility greenhouse.

In addition, here, the facility greenhouse 10 may receive data from the sensors and transmit control messages to the sensors or various apparatuses such as a light, a temperature controller, and a humidity controller installed in the facility greenhouse.

In addition, the facility greenhouse 10 may control light, temperature, humidity, and the like according to a preset reference model. Here, the reference model may be renewed by the apparatus 40 for optimizing crop production efficiency, and the renewed model may be applied to the system as a reference model.

Here, the mobile apparatus 20 may receive a farming daily log from a user, and growth information of a crop grown in the facility greenhouse and images of a crop afflicted with a disease may be written in the farming daily log.

That is, here, the mobile apparatus may receive growth information, such as an amount of fertilizer provided by the user for crop growth, a unit price of the fertilizer, a grown size, and an amount of harvested fruit, and disease information including images of a crop afflicted with a disease.

Here, the farm cloud server 30 may collect sensing data from the facility greenhouse 10 and collect the growth information or the disease information from the mobile apparatus 20. Here, the information collected as described above may also be stored in a Hadoop cluster configured to store a large amount of and various pieces of information.

Here, the apparatus 40 for optimizing crop production efficiency may analyze production efficiency of the facility greenhouse by analyzing supply resource information and disease information extracted from the collected sensor data and growth information, and by analyzing malfunction information of a sensor, a controller, or the like in a greenhouse environment. The result of the analysis may be converted into the form of a warning or recommendation and provided to the facility greenhouse 10 or the mobile apparatus 20 through the farm cloud server 30.

Here, the malfunction information of the sensor or the controller may be collected by a user inputting the malfunction information to the mobile apparatus 20, or by the facility greenhouse 10 receiving a malfunction signal from the controller installed in the facility greenhouse 10.

Here, although one facility greenhouse 10 and one mobile apparatus 20 are illustrated, since one facility greenhouse 10 and one mobile apparatus 20 may be included in each farm, it should be understood that the farm cloud server 30 or the apparatus 40 for optimizing crop production efficiency receives data from a plurality of facility greenhouses and mobile apparatuses.

In addition, although the farm cloud server 30 and the apparatus 40 for optimizing crop production efficiency are illustrated as being separated, it should be understood that the farm cloud server 30 and the apparatus 40 for optimizing crop production efficiency may be integrally formed as one apparatus or server, and may include the Hadoop cluster.

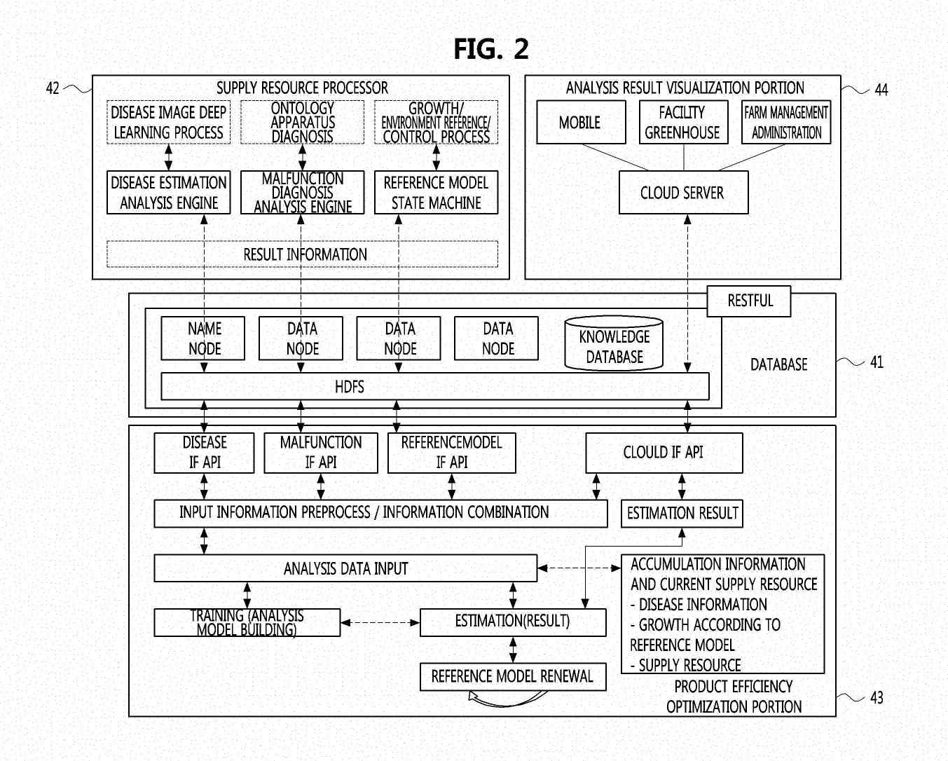

FIG. 2 is a conceptual diagram illustrating the overall system for performing the method of optimizing crop production efficiency according to one embodiment of the present invention from a functional viewpoint.

Referring to FIG. 2, a database 41, which may be formed with the Hadoop cluster, may store sensor data collected in a facility greenhouse of a farm, and growth information and disease information collected by a mobile apparatus.

A supply resource processor 42 may include a disease prediction analysis engine configured to determine whether a disease occurs and estimate a possibility of disease occurrence by performing deep learning analysis on disease images and using information stored in the database, a malfunction diagnosis analysis engine configured to diagnosis and analyze whether a malfunction of the controller and the sensor occurs, and a reference model state machine configured to compare the growth information and the sensor data with those of the reference model and extract an amount of supply resources according to the reference model.

A production efficiency optimization portion 43 may receive information regarding whether a disease occurs, the probability of disease occurrence, whether a malfunction occurs, the reference model, and the amount of supply resources as input data for optimizing production efficiency of a greenhouse through an interface (IF) application protocol interface (API), and the input data may be input as data for analysis through preprocessing and information combining for analysis. Here, the preprocessing and the information combining may be processes in which a form in which the input data is changed or the respective pieces of input data are combined for analysis.

When the input data is accumulated, the production efficiency optimization portion 43 may build an analysis model for production efficiency by training an influence of each component of current supply resources (for example, whether a disease occurs, the kind of disease, an amount of fertilizer, a provided temperature value, and a provided humidity value) of the production efficiency. The production efficiency may be estimated by using the analysis model built as described above at a control point in each ordered period. Here, the estimated result for each farm may be applied to a mobile terminal or facility greenhouse of a user to provide a warning about the production efficiency or a recommendation thereto.

The production efficiency optimization portion 43 may renew the reference model by reflecting a result value of a superior farm and the ordered period thereon to dynamically apply the reference model to optimize crop production efficiency.

An analysis result visualization portion 44 may provide a result of production efficiency estimation, a control value of each required component according to the production efficiency estimation, or a result corresponding to a control point in an ordered period to the farm cloud server, the mobile apparatus, the facility greenhouse, and the like through a cloud interface (cloud IF API).

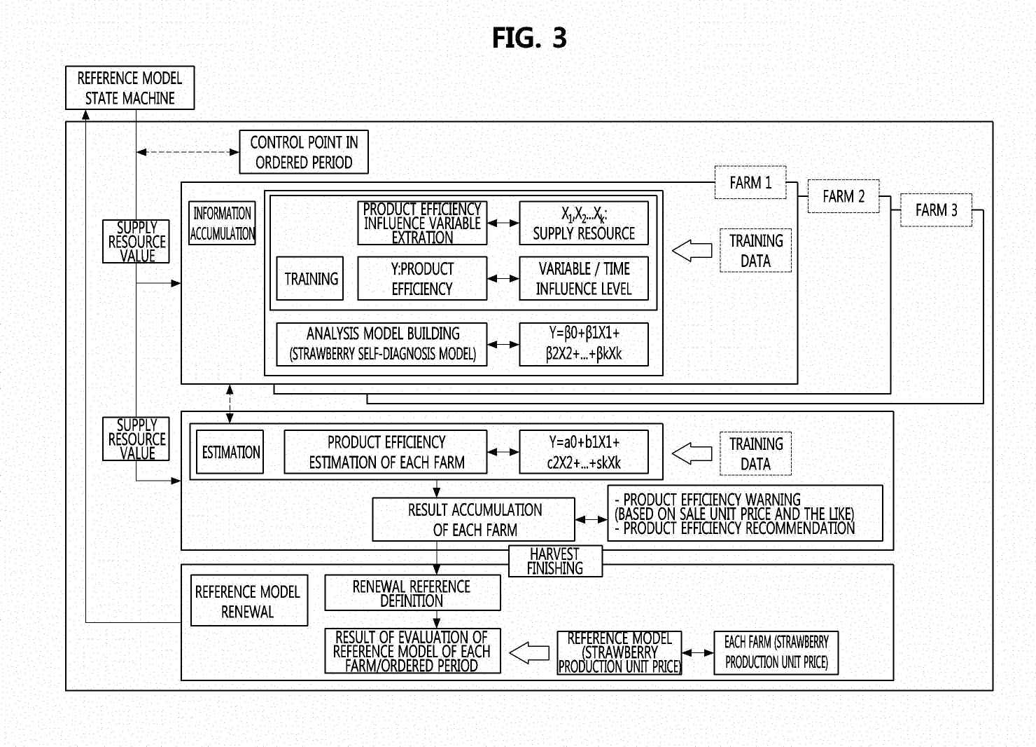

FIG. 3 is a conceptual diagram illustrating an algorithm for optimizing crop production efficiency according to one embodiment of the present invention.

Supply resource values and training data for building a production efficiency analysis model may be provided from a reference model state machine at a control point in each ordered period.

Here, the supply resource values may refer to an amount of fertilizer, a temperature control value, a humidity control value, and the like provided to a practical facility farm based on a reference model, and the training data may be input data for additional training in addition to data acquired by the facility farm, and may be production efficiency according to supply resource values of other farms or production efficiency according to supply resources acquired from known papers or proven experimental data.

Variables Xi which influence production efficiency may be extracted on the basis of the provided supply resource values and training data, and an influence of the extracted variables or a variable according to time on the production efficiency may be trained.

Here, the production efficiency may be defined as an amount of production, an amount of production relative to a supplied production cost, or the like.

Meanwhile, an analysis model for showing production efficiency according to supply resources (variables) may be built as a training result of the production efficiency relative to the supply resources. Here, since the analysis model uses data of a facility greenhouse of a corresponding farm, different analysis models may be built according to supply resource information used by each farm. Here, production efficiency according to a variable may be extracted by machine training, or may be extracted by a regression analysis, a time series analysis, or the like.

Production efficiency of a corresponding farm may be estimated on the basis of the analysis model built as described above by using the supply resource values and test data of the corresponding farm. Here, the test data may not be provided from the corresponding farm, but may be preset values included in the analysis model as basic variable values.

The estimation result of the production efficiency may be a kind of situational information and may be visualized and provided to a farm and an operator, and when the production efficiency is low, a warning is performed or insufficient supply resource values may be recommended to increase the production efficiency.

When a crop is completely harvested, production efficiency of each farm and production efficiency in each ordered period may be compared according to a renewal reference of the reference model. A production efficiency model of the best farm may be selected to evaluate the currently applied reference model.

When the production efficiency value according to the reference model is less than that of the current farm/ordered period, which is superior, the reference model may be renewed on the basis of growth environment information or growth information (a lower leaf picking and the like) of the superior farm or the superior ordered period.

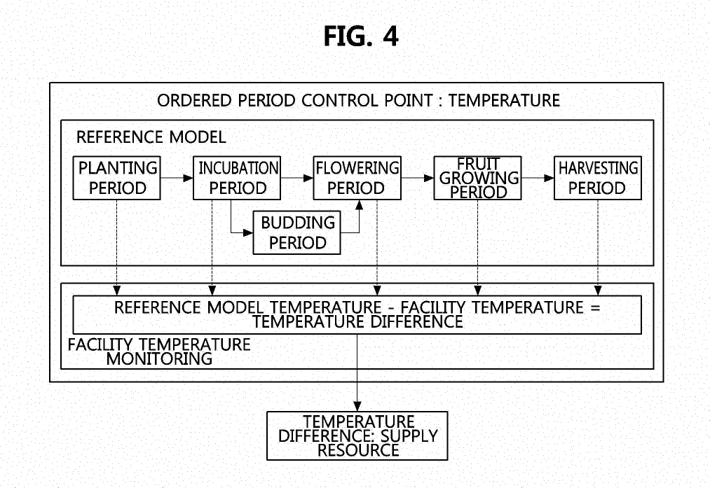

FIG. 4 is a conceptual diagram for describing supply resources according to a reference model in the case in which a control point in an ordered period according to one embodiment of the present invention is temperature.

Referring to FIG. 4, a reference model may show growth environment information such as temperature, humidity, and the like according to ordered periods which include a planting period, an incubation period, a flowering period, and the like.

When temperature is exemplified as a control point in an ordered period, a differential value between a temperature of the reference model of the current ordered period and a temperature collected by a sensor in a facility greenhouse may be extracted as a supply resource value. Here, the extracted supply resource value may be used as an input value for building a production efficiency analysis model, or may be provided as a recommendation to a farm having a facility greenhouse as a resource value which should be provided to the facility greenhouse.

Here, when the supply resource value relates to a growth environment such as temperature, the supply resource value may be drawn as the differential value, but when the supply resource value relates to a growth activity, such as the case in which a lower leaf picking operation is performed by an operator of a farm, the supply resource value may be extracted as a value for denoting whether the growth activity is performed rather than relating to the growth environment. For example, the supply resource value may be extracted as a value which is “1” when the growth activity is performed, and “0” when a growth activity is not performed, or may also be extracted as a value weighted on “1” or “0”.

In addition, the reference model may be additionally input or preset, or each ordered period may be differently set according to the kind of crop.

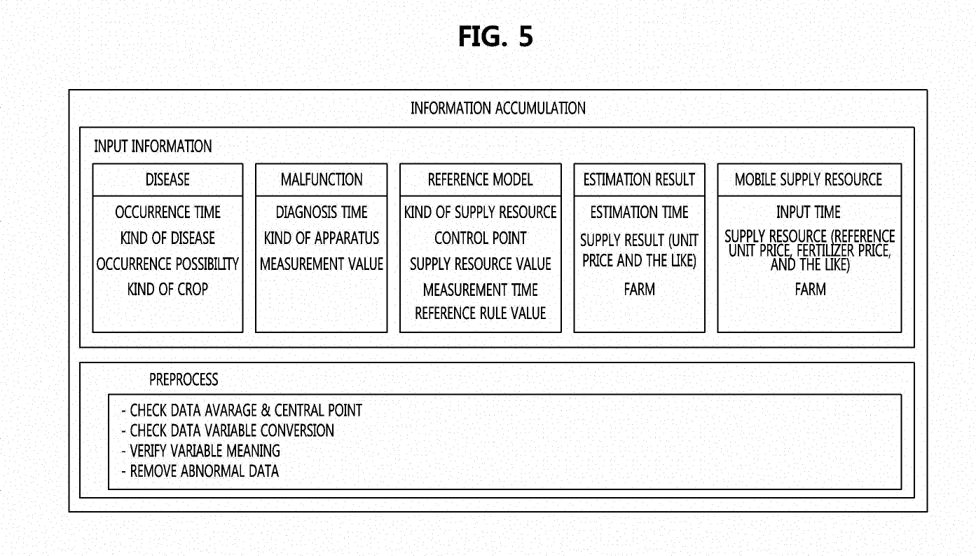

FIG. 5 is a conceptual diagram related to data accumulation for optimizing crop production efficiency according to one embodiment of the present invention.

Referring to FIG. 5, various pieces of supply resource information may be continuously accumulated to be applied to build an analysis model as input data for optimizing crop production efficiency.

Here, information related to a disease, which is one piece of input data, may include a disease occurrence time, the kind of disease, an occurrence possibility, and the kind of crop.

Here, the kind of disease and the occurrence probability may be obtained by analyzing a crop or images related to a disease collected by the mobile apparatus using deep learning, and the occurrence time and the kind of crop may be acquired by collecting data additionally input by a farm operator (or a user) through the mobile apparatus and the like.

In addition, information related to a malfunction of an apparatus among the input data may include the kind of apparatus, a value measured by the apparatus, and a diagnosis time.

In addition, the input data for a reference model may be kinds of supply resources, values of supply resources, and the like according to each ordered period, and data input as a result of estimation which is previously performed may be supply result values (a production cost, an amount of production, and the like) of each farm and a time at which efficiency is estimated.

In addition, data input as data input by an operator through the mobile apparatus may be a time at which the data is input, supply resource information such as a reference unit price and the price of fertilizer, a name of a farm, and the like.

The data input as described above may be sorted or converted into data necessary for building an analysis model by checking a data average and a center point, checking data variable conversion, verifying meanings between variables, checking abnormal data removing, and the like.

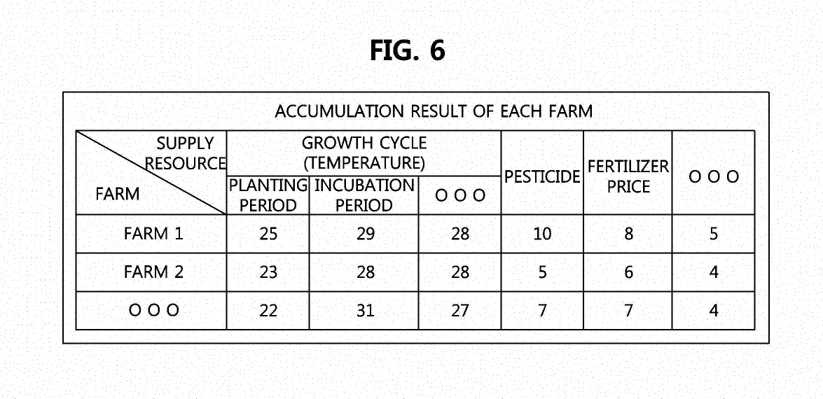

FIG. 6 is a conceptual table related to result data of each farm for optimizing crop production efficiency according to one embodiment of the present invention.

Referring to FIG. 6, a result of collecting temperature data, an amount of input pesticide, an amount of fertilizer, and the price of the fertilizer according to growth cycle (or ordered period) for each farm may be shown as supply sources.

Specifically, in the case of Farm 1, a temperature of 25° C. may be collected in a planting period, a temperature of 29° C. may be collected in an incubation period, and 10 may be collected as an amount of input pesticide.

That is, supply resources provided to each farm in each ordered period may be continuously collected and stored to be applied as data to determine a superior farm or to provide a recommendation or warning to a corresponding farm about supply resources through estimation according to the reference model.

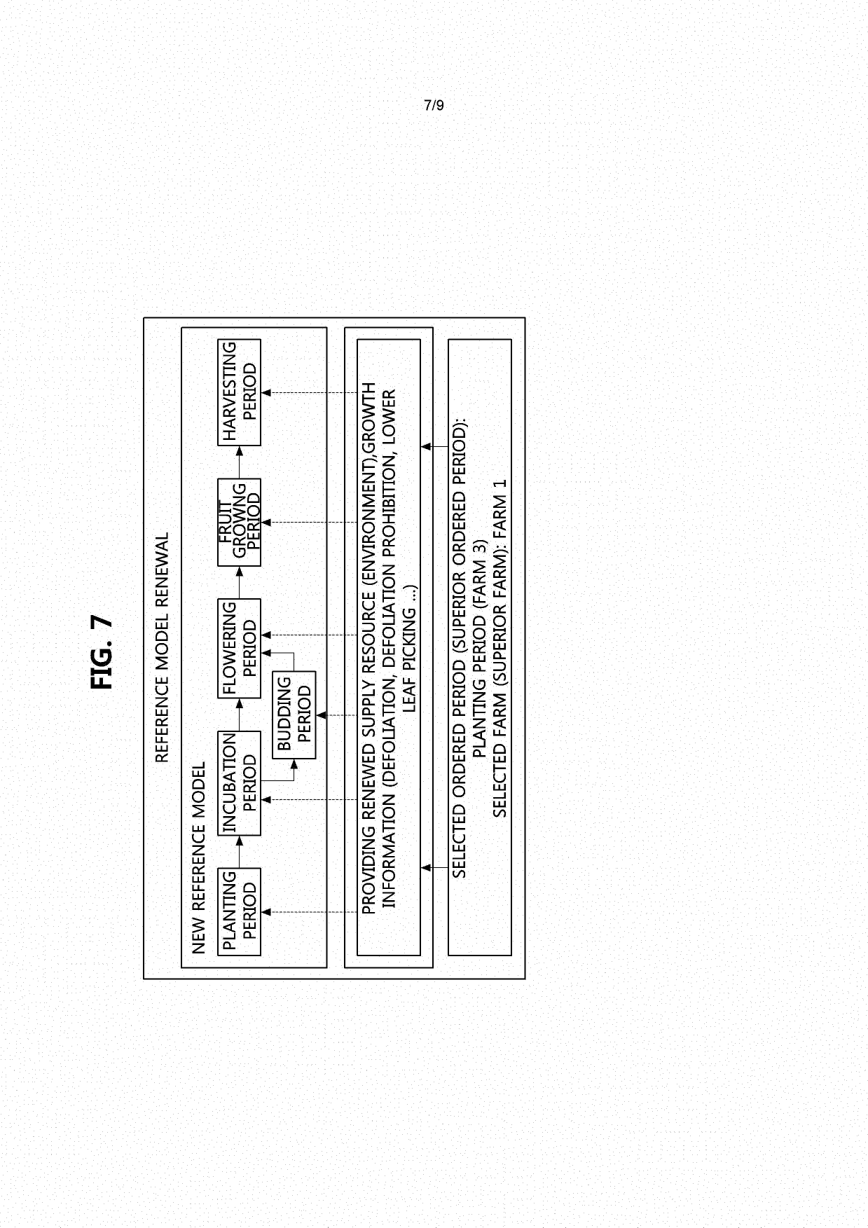

FIG. 7 is a conceptual diagram related to a reference model renewal for optimizing crop production efficiency according to one embodiment of the present invention.

A process in which a reference model is renewed to optimize crop production efficiency may be described with reference to FIG. 7.

For example, a farm having the best production efficiency may be selected, and the farm and an ordered period having the best production efficiency may also be selected in a specific ordered period on the basis supply resource information collected by each farm, as illustrated in FIG. 6.

A currently applied reference model may be renewed on the basis of supply resource information or growth information (defoliation, defoliation prohibition, lower leaf picking, and the like) collected by the superior farm selected as described above.

Specifically, growth environment information, such as temperature and humidity, and the growth information, such as lower leaf picking, provided from the superior farm in the specific ordered period may be stored according to each ordered period to be applied as a new reference model.

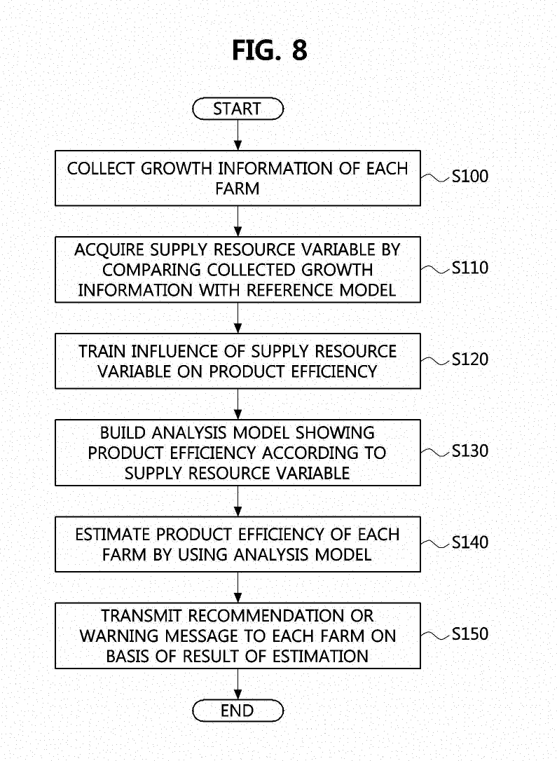

FIG. 8 is a flowchart illustrating the method of optimizing crop production efficiency according to one embodiment of the present invention.

Referring to FIG. 8, the method of optimizing crop production efficiency may include an operation of collecting growth information of each farm (S100), an operation of acquiring at least one supply resource variable by comparing the collected growth information with a preset reference model (S110), an operation of training an influence of the at least one supply resource variable on production efficiency (S120), and an operation of building an analysis model configured to show the production efficiency according to the at least one supply resource variable as a result of the training (S130).

Here, each of the farms may refer to a server, a computer, or the like configured to control a facility greenhouse of the farm.

Here, the reference model may be preset as a model in which supply resource values (an amount of fertilizer, temperature, humidity, and the like) generally known and applied in each ordered period are defined, may be renewed after each of the farms performs harvesting, and may be optimized to a local environment of each of the farms.

Here, the operation of acquiring the supply resource variable (S110) may include sorting information which matches the reference model among the collected growth information and converting the sorted information into a variable value according to the reference model. For example, a differential value between a temperature or humidity value required by the reference model and a temperature or humidity value required by the growth information may be applied as a supply resource variable value.

Here, the operation of collecting the growth information (S100) may include collecting growth information in each ordered period according to the preset reference model.

Here, the growth information may include at least one among disease information, diagnostic information of a growth controller, growth environment information, and growth activity information.

Here, the growth environment information may indicate temperature, humidity, and the like which influence crop growth, and may be collected by various sensors installed in the facility greenhouse of each of the farms.

Here, the growth activity information may be related to an operator's activities that are necessary for crop growth, and may include whether leaves of a crop are picked.

Here, the disease information may be acquired by taking pictures of a crop which is suspected of being afflicted with a disease with a mobile apparatus used by an operator of each of the farms, receiving the taken disease images from the mobile apparatus, and processing the disease images.

Specifically, the disease information may include a result of estimating one of a disease occurrence probability and whether a disease occurs by performing deep learning on the disease images input by the operator of each of the farms.

Here, the diagnostic information of the growth controller may include a result of diagnosing whether a malfunction of the growth controller occurs by comparing a control value of the growth controller with a growth environment value corresponding to the growth controller.

Here, the growth controller may refer to various apparatuses installed in the facility greenhouse of each of the farms and may be configured to control a growth environment such as temperature, humidity, light, and the like in the facility greenhouse.

Here, the control value and the growth environment value of the growth controller may be acquired by confirming control messages transmitted to various sensors and the growth controller installed in each of the farms. Here, control of the growth controller may be performed by a server installed in a facility farm or an apparatus for optimizing crop production which will be described below.

Here, the method of optimizing crop production efficiency may further include an operation of estimating production efficiency according to the growth information of each of the farms using an analysis model (S140) and an operation of transmitting a recommendation or warning message to each of the farms on the basis of the result of the estimation (S150).

Here, the operation of transmitting the message (S150) may include transmitting a message which recommends that a supply resource values be provided to each of the farms according to the reference model when the estimated production efficiency is less than production efficiency according to the reference model.

Here, the operation of transmitting the message (S150) may include transmitting a warning message including the estimated production efficiency when the estimated production efficiency is less than the production efficiency according to the reference model.

Here, the method of optimizing crop production efficiency may further include an operation of preprocessing the growth information after the operation of collecting the growth information.

Here, the operation of preprocessing may include an operation of verifying a meaning of the growth information or checking an average value or central point of the growth information to remove information determined as an abnormal value from the growth information or to convert a data form of the growth information into a data form with which the growth information may be processed.

Here, when harvesting at each of the farms is confirmed to be finished, the method of optimizing crop production efficiency may further include an operation of selecting a farm or ordered period having the best production efficiency by evaluating production efficiency of each of the farms, an operation of comparing the production efficiency according to the selected farm or ordered period with the production efficiency according to the preset reference model, and an operation of renewing the preset reference model by reflecting the growth information according to the selected farm or ordered period thereon when the production efficiency according to the selected farm or ordered period is greater than the production efficiency according to the preset reference model.

Here, when the product efficiency of each of the farms is calculated in each ordered period, a superior ordered period may refer to an ordered period of a farm having the best efficiency among calculated production efficiencies in each of the ordered periods.

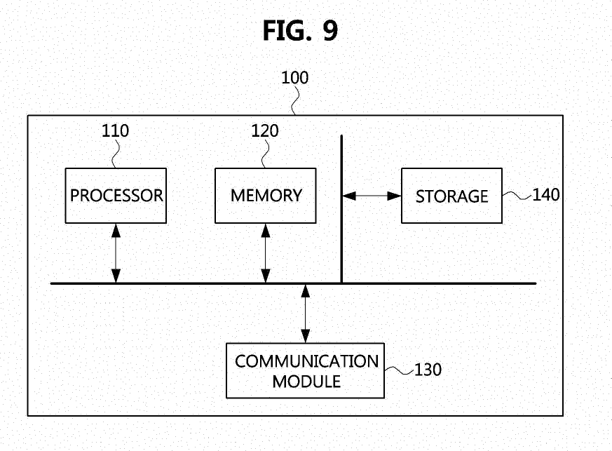

FIG. 9 is a conceptual diagram related apparatus for optimizing the crop production efficiency according to one embodiment of the present invention apparatus.

Referring to FIG. 9, an apparatus 100 for optimizing crop production efficiency may include at least one processor 110 and a memory 120 configured to store commands which command the at least one processor 110 to perform at least one operation.

Here, the apparatus 100 for optimizing crop production efficiency may further include a storage 140 configured to store collected growth information, and here, the storage 140 may be a Hadoop cluster.

Here, the apparatus 100 for optimizing crop production efficiency may further include a communication module 130 configured to receive the growth information of each farm to collect the growth information, and transmit a recommendation or warning message to each of the farms.

Here, the at least one operation may include an operation of collecting growth information of each of the farms, an operation of acquiring at least one supply resource variable by comparing the collected growth information with a preset reference model, an operation of training an influence of the supply resource variable on production efficiency, and an operation of building an analysis model configured to show the production efficiency according to the at least one supply resource variable as a result of the training.

Here, the operation of collecting the growth information may include collecting the growth information in each ordered period according to the preset reference model.

Here, the growth information may include at least one among disease information, diagnostic information of the growth controller, growth environment information, and growth activity information.

Here, the disease information may include a result of estimating one of a disease occurrence probability and whether a disease occurs by performing deep learning on disease images input by an operator of each of the farms.

Here, the diagnostic information of the growth controller may include a result of diagnosing whether a malfunction of the growth controller occurs by comparing a control value of the growth controller with a growth environment value corresponding to the growth controller.

Here, the commands may command the at least one processor to further perform an operation of estimating production efficiency according to the growth information of each of the farms by using the analysis model, and an operation of transmitting a recommendation or warning message to each of the farms on the basis of the estimated result.

Here, the operation of transmitting the message may include transmitting a message which recommends that a supply resource value should be provided to each of the farms according to the reference model when the estimated production efficiency is less than production efficiency according to the reference model.

Here, the commands may command the at least one processor to further perform preprocessing the growth information after the operation of collecting the growth information.

Here, the operation of preprocessing may include an operation of verifying a meaning of the growth information or checking an average value or central point of the growth information to remove information determined as an abnormal value from the growth information or to convert a data form of the growth information into a data form with which the growth information may be processed.

Here, when harvesting at each of the farms is confirmed to be finished, the commands may command the at least one processor to further perform selecting a farm or ordered period having the best production efficiency by evaluating production efficiency of each of the farms, an operation of comparing the production efficiency according to the selected farm or ordered period with the production efficiency according to the preset reference model, and an operation of renewing the preset reference model by reflecting the growth information according to the selected farm or ordered period thereon when the production efficiency according to the selected farm or ordered period is greater than the production efficiency according to the preset reference model.

Here, the apparatus for optimizing crop production efficiency may be, for example, a desktop computer, a laptop computer, a notebook, a smart phone, a tablet personal computer (PC), a mobile phone, a smart watch, a smart glass, an e-book reader, a portable multimedia player (PMP), a handheld game console, a navigation apparatus, a digital camera, a digital multimedia broadcasting (DMB) player, a digital audio recorder, a digital audio player, a digital video recorder, a digital video player, and a personal digital assistant (PDA) which may communicate with others.

Here, the apparatus 100 for optimizing crop production efficiency may correspond to the apparatus 40 for optimizing crop production efficiency illustrated in FIG. 1, or may further include the farm cloud server 30 illustrated in FIG. 1.

In addition, the apparatus 100 for optimizing crop production efficiency may include a functional module including at least one among the database 41, the supply resource processor 42, the production efficiency optimization portion 43, and the analysis result visualization portion 44 according to FIG. 2 when the apparatus is divided into functional modules.

The methods according to the present invention may be realized as a form of a program instruction which may be performed by various computers and may be written on computer readable media. The computer readable media may include a program instruction, a data file, a data structure, a combination thereof, and the like. The program instruction written on the computer readable media may be specifically designed or programmed for the present invention or may be known to and useable by those skilled in the computer software.

The computer readable media may include a hardware device, for example, a read-only memory (ROM), a random access memory (RAM), a flash memory, and the like, which are specifically formed to store and execute program instruction. The program instruction may include, for example, machine language codes such as those generated by a compiler, as well as high-level language codes which may be executed by a computer using an interpreter, or the like. The above-described hardware device may be configured to operate by using at least one software module to perform the operations of the present invention, and vice versa.

In addition, the above-described method or apparatus may be formed by combining all or some of the components or functions or partially separating the components or functions.

When the method of optimizing crop production efficiency and the apparatus for the same according to the present invention is used, crop production efficiency may be optimized according to a local environment of each farm.

In addition, since a recommendation or warning is provided according to an optimized reference model for growth control, there is an advantage in that each of the farms can easily operate a facility greenhouse.

While the example embodiments of the present invention have been described in detail, it should be understood to those skilled in the art that various changes, substitutions and alterations may be made herein without departing from the scope of the invention.

What is claimed is:

1. A method of optimizing crop production efficiency performed by an apparatus for optimizing crop production efficiency, the method comprising:
collecting growth information of each farm;
acquiring at least one supply resource variable by comparing the collected growth information with a preset reference model;
training influence of the at least one supply resource variable on production efficiency; and
building an analysis model which shows production efficiency according to the at least one supply resource variable as a result of the training.

2. The method of claim 1, wherein the collecting of the growth information includes collecting the growth information in each ordered period according to the preset reference model.

3. The method of claim 1, wherein the growth information includes at least one among disease information, diagnostic information of a growth controller, growth environment information, and growth activity information.

4. The method of claim 3, wherein the disease information denotes a result of estimating one of a disease occurrence probability and whether a disease occurs by performing deep learning on a disease image input by an operator of each of the farms.

5. The method of claim 3, wherein the diagnostic information of the growth controller denotes a result of diagnosing whether a malfunction of the growth controller occurs by comparing a control value of the growth controller with a growth environment value corresponding to the growth controller.

6. The method of claim 1, further comprising:
estimating production efficiency according to the growth information of each of the farms by using the analysis model; and
transmitting a recommendation or warning message to each of the farms on the basis of a result of the estimation.

7. The method of claim 6, wherein the transmitting of the message includes transmitting a message which recommends that a required supply resource value be supplied to each of the farms according to the reference model when the estimated production efficiency is less than production efficiency according to the reference model.

8. The method of claim 1, further comprising preprocessing the growth information after the collecting of the growth information.

9. The method of claim 8, wherein the preprocessing includes verifying a meaning of the growth information or checking an average value or central point of the growth information to remove information determined as an abnormal value from the growth information or to convert a data form of the growth information into a data form with which the growth information is processable.

10. The method of claim 1, when harvesting at each of the farms is confirmed to be finished, further comprising:
selecting a farm or ordered period having the best production efficiency by evaluating production efficiency of each of the farms;
comparing the production efficiency according to the selected farm or ordered period with production efficiency according to the preset reference model; and
renewing the preset reference model by reflecting the growth information according to the selected farm or ordered period thereon when the production efficiency according to the selected farm or ordered period is greater than the production efficiency according to the preset reference model.

11. An apparatus for optimizing crop production efficiency, the apparatus comprising:
at least one processor; and
a memory which stores commands configured to command the at least one processor to perform at least one operation,
wherein the at least one operation includes:
collecting growth information of each farm;
acquiring at least one supply resource variable by comparing the collected growth information with a preset reference model;
training influence of the at least one supply resource variable on production efficiency; and
building an analysis model which shows production efficiency according to the at least one supply resource variable as a result of the training.

12. The apparatus of claim 11, wherein the collecting of the growth information includes collecting the growth information in each ordered period according to the preset reference model.

13. The apparatus of claim 11, wherein the growth information includes at least one among disease information, diagnostic information of a growth controller, growth environment information, and growth activity information.

14. The apparatus of claim 13, wherein the disease information includes a result of estimating one of a disease occurrence probability and whether a disease occurs by performing deep learning on a disease image input by an operator of each of the farms.

15. The apparatus of claim 13, wherein the diagnostic information of the growth controller includes a result of diagnosing whether a malfunction of the growth controller occurs by comparing a control value of the growth controller with a growth environment value corresponding to the growth controller.

16. The apparatus of claim 11, wherein the commands command the at least one processor to further perform:
estimating production efficiency according to the growth information of each of the farms by using the analysis model; and
transmitting a recommendation or warning message to each of the farms on the basis of a result of the estimation.

17. The apparatus of claim 16, wherein the transmitting of the message includes transmitting a message which recommends that a required supply resource value be supplied to each of the farms according to the reference model when the estimated production efficiency is less than production efficiency according to the reference model.

18. The apparatus of claim 11, wherein the commands command the at least one processor to further perform preprocessing the growth information after the collecting of the growth information.

19. The apparatus of claim 18, wherein the preprocessing includes verifying a meaning of the growth information or checking an average value or central point of the growth information to remove information determined as an abnormal value from the growth information or to convert a data form of the growth information into a data form with which the growth information is processable.

20. The apparatus of claim 11, wherein, when harvesting at each of the farms is confirmed to be finished, the commands command the at least one processor to further perform:
selecting a farm or ordered period having the best production efficiency by evaluating production efficiency of each of the farms;
comparing the production efficiency according to the selected farm or ordered period with production efficiency according to the preset reference model; and
renewing the preset reference model by reflecting the growth information according to the selected farm or ordered period thereon when the production efficiency according to the selected farm or ordered period is greater than the production efficiency according to the preset reference model.
